(19) United States
(12) Patent Application Publication
(10) Pub. No.: US 2005/0173675 A1
(43) Pub. Date: Aug. 11, 2005

(54) Method of manufacturing a luminescent material

(75) Inventors: Peter J Schmidt, Aachen (DE); Thomas Justel, Witten (DE); Cornelis Reinder Ronda, Aachen (DE); Detlef Uwe Wiechert, Alsdorf (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/513,278

(22) PCT Filed: Apr. 30, 2003
(86) PCT No.: PCT/IB03/01657

(30) Foreign Application Priority Data
May 7, 2002 (DE) 102 20 292.3

(51) Int. Cl. C09K 11/02

(52) U.S. Cl. 252/301.36

(57) ABSTRACT

The invention relates to a method of manufacturing europium-doped (Ca1-xSrx)S (0£×£1) luminescent material with a short decay time and a high thermal extinction temperature, wherein the europium-doped strontium sulfide is subjected to at least a first caldnation step at high temperatures in the presence of at least one iodine compound. The invention further relates to the luminescent material as such and to its use for light-emitting components such as light-emitting diodes (LEDs) and laser diodes coated with luminescent materials.

The invention relates to a method of manufacturing a europium-doped (Ca₁₋ₓSrₓ)S (0<x<1) luminescent material with a short decay time and a high thermal extinction temperature, to the luminescent material itself, and to its use in light-emitting components such as light-emitting diodes (LEDs) and laser diodes coated with luminescent materials.

Sulfates, carbonates, oxalates, or oxides are generally used as basic materials for manufacturing alkaline earth sulfide fluorescent powders in the prior art. High temperatures of more than 900° C. are necessary for the manufacture of such powders so as to reduce oxygen-containing bonds to the corresponding sulfide compounds and to achieve as complete as possible a distribution of activators and co-activators in the host lattice.

Three different methods of manufacturing alkaline earth sulfide fluorescent powders are known in the prior art; for a general summary see: Ghosh and Ray, Prog. Crystal Growth and Chart. 25 (1992) 1):
1. reduction of alkaline earth sulfate with hydrogen,
2. sulfurizing of alkaline earth carbonate or oxide with H₂S or CS₂,
3. sulfurizing and melting method, this is a modified version of the industrial process for manufacturing rare earth metal oxide sulfide phosphors.

The method mentioned third is based on the alkali-polysulfide melting method by means of which very well crystallized phosphor particles are obtained, as is described by Okamoto et al. in U.S. Pat. No. 4,348,299. This method, however, has several disadvantages for the manufacture of SrS:Eu luminescent materials. Thus a molten mass is usually obtained after calcination, which is to be washed with an aqueous solution so as to dissolve the recrystallized alkali polysulfide melt. The method mentioned can be very well used in the case of a calcium sulfide phosphor, because this material is stable in aqueous surroundings. This is not true, however, for materials comprising strontium sulfide, because these are not stable in aqueous surroundings, so that the method is unsuitable for this.

A further disadvantage is that an excess of alkali atoms is present in the host lattice, so that these alkali acceptors are to be compensated for equalizing the charge. This is achieved, for example, by oxidation of Eu(II) to Eu(III), which is accompanied by a strong reduction in the desired Eu(II) emission, as represented below:
Na₂S+2Sr_{Sr}+2Eu_{Sr}→2Na_{Sr}′+2Eu_{Sr}+2SrS (1)

The crystallinity of alkaline sulfide fluorescent powder manufactured by one of the methods mentioned sub 1) or 2) above may be improved by an additional calcination step and by the use of a flow promoting agent, for example ammonium chloride or ammonium bromide, as described by Yocom and Zaremba in U.S. Pat. No. 4,839,092 for NH₄X (X═Cl, Br). Ammoniumchloride and bromide readily react with sulfide compounds, after thermal dissociation during calcination, whereby the corresponding halogen compounds are formed, while a reducing atmosphere is created by the evolving NH₃, as shown below:
2NH₄X+SrS→2NH₃+H₂S+SrX₂ (2)

The strontium halide SrX₂ has a much lower melting point than strontium sulfide, so that a liquid phase is formed during the heating step, surrounding the SrS particle. A dissolution and recrystallization of the strontium sulfide at the solid-liquid boundary surface leads to a grain growth of the particles and to an improved particle morphology. In addition, well-crystallized particles and a good particle morphology are important factors which are decisive for the efficiency of the luminescent properties of the material, especially if the excitation wave line lies in the visible spectral range.

The incorporation of halogen atoms into the strontium sulfide host lattice during the calcination step leads to the creation of positive charge defects in the anion sub-lattice, which is compensated by cation voids:
SrX₂+2S_{S}+Sr_{Sr}→2X_{S}·+V_{Sr}″+2SrS (3)

These charge lattice defects act as electrons and holes, so that a strong afterglow of the above luminescent material is obtained after excitation. This effect may be utilized for the manufacture of strontium sulfide phosphor with a long afterglow, as described in U.S. Pat. No. 4,839,092. A disadvantage of fluorescent materials with such a long afterglow and with such a high density of defects is that they have a strong thermal extinction of the luminescence, i.e. a strong decrease in the luminescent power at increased temperatures. Such materials are accordingly not suitable for most lighting applications.

Koichi and Akira, Japan Pat. No. 60,101,172 describe a method of improving the afterglow properties and the brightness of europium-doped strontium sulfide by means of a thermal treatment of the luminescent material with an alkaline earth metal vapor under a given vapor pressure. A major disadvantage of this method is that alkaline earth metal vapors are toxic and exhibit a very high reactivity with most materials in the reaction chamber. This method is accordingly not suitable for industrial mass manufacture of luminescent materials.

It is an object of the present invention to provide a method of manufacturing highly effective, europium-doped (Ca₁₋ₓSrₓ)S (0≦x≦1) with short luminescence decay times and a high thermal extinction temperature, while the above disadvantages of the prior art are avoided.

According to the invention, a europium-doped (Ca₁₋ₓSrₓ)S (0≦x≦1) luminescent material with a short decay time and a high thermal extinction temperature can be manufactured in that europium-doped (Ca₁₋ₓSrₓ)S (0≦x≦1) is exposed to at least a first calcination step at high temperatures in the presence of at least one iodine compound.

In the method according to the invention, the (Ca₁₋ₓSrₓS:Eu,I) (0≦x≦1) luminescent material should be calcinated at least once in a reducing atmosphere.

Suitable reducing atmospheres are formed by an inert atmosphere, such as argon or nitrogen, which comprises sulfur, preferably sulfur in elementary form.

It was found to be advantageous to add small quantities of hydrogen to the inert atmosphere so as to prevent an oxidation of the luminescent material, in particular during calcination.

The europium dopant is present as a cation and the iodine as an anion in the lattice of the (SrS:Eu,I) luminescent material.

It is advantageous when the europium-doped (Ca₁₋ₓSrₓS:Eu,I) (0≦x<1) luminescent material comprising iodine, i.e. in the form of iodine ions I⁻, is subjected at least to a second calcination step at high temperatures, preferably in the presence of a reducing atmosphere.

The afterglow period can be shortened and the brightness can be increased in that the luminescent material is crushed, for example in a ball mill, and is subsequently subjected to a calcination step.

The temperatures of the calcination step or steps may be ≧900° C. in the methods used according to the invention. The temperatures preferably lie in a range from 950° C. to 1500° C., preferably 1050° C. to 1200° C.

In a preferred embodiment of the method according to the invention, the luminescent material is fired in an inert atmosphere containing sulfur, preferably 2 to 4% of sulfur by weight, possibly in the presence of small quantities of hydrogen.

Preferably, the quantity of added europium lies between 0.001 and 0.5 atom %, preferably between 0.005 and 0.2 atom %, with respect to the Ca₁₋ₓSrₓS (0≦x<1).

To promote the crystal growth of the europium-doped Ca₁₋ₓSrₓS particles (0≦x≦1), at least one iodine compound, preferably chosen from the group comprising I₂ vapor, ammonium iodide (NH₄I), strontium iodide (SrI₂), calcium iodide (CaI₂), magnesium iodide (MgI₂), zinc iodide (ZnI₂), and/or barium iodide (BaI2), is added.

The proportion of added iodine compounds should lie in a range of between 0.1 and 5 atom %, preferably in a range of between 0.5 and 4 atom %, and preferably in a range of between 1 and 3 atom %, with respect to the Ca₁₋ₓSrₓS (0≦x≦1).

After calcination of the luminescent material, the iodine anion content of the luminescent material according to the invention should be ≦5000 ppm, preferably ≦1000 ppm, more preferably ≦500 ppm, even more preferably ≦300 ppm, highly preferably ≦200 ppm, and most preferably ≦100 ppm. The lower the proportional quantity of iodine anions in the luminescent material according to the invention, the better luminescent properties are observed for the luminescent material according to the invention. After calcination of the luminescent material according to the invention with iodine anions, the iodine anion content of the luminescent material according to the invention should ideally be as close to zero as possible.

It is preferred according to the invention that 2 atom % of ammonium iodide is calcinated together with the Ca₁₋ₓSrₓS:Eu (0≦x≦1) and with 2 to 4% by weight of sulfur in a loosely closed, argon-filled corundum tube at temperatures of between 1050° C. and 1150° C. for 1 to 2 hours in a nitrogen flow. The use of a corundum tube is advantageous for keeping hydrogen iodide, which is formed in the thermal dissociation of ammonium iodide, in the reaction zone so that the hydrogen iodide thus formed reacts with the strontium sulfide, forming a temporary liquid phase at the particle surfaces.

After this heating step, Ca₁₋ₓSrₓS:Eu,I (0≦x≦1) luminescent material exhibits a strong afterglow. The afterglow can be shortened and the brightness can be increased in that the luminescent material is crushed, for example by means of a ball mill, followed by a final firing or calcinating step in a reducing nitrogen atmosphere, preferably also containing sulfur, for 1 to 2 hours at temperatures of 950° C. to 1050° C.

This subsequent second calcination step renders it possible to remove most lattice defects of the luminescent material, i.e. iodine anion atoms in sulfur atom locations and strontium cation atom defects or Ca₁₋ₓSrₓ cation atom defects, while in addition surface defects of the particles are restored again.

SrS:Eu,I luminescent material emitting in the visible wavelength range of 610-620 nm, i.e. in the orange color wavelength range, and Ca₁₋ₓSrₓS:Eu,I (0≦x≦1) luminescent material emitting in the 610-655 nm wavelength range can be obtained by the method according to the invention as described above. The higher the Ca content of the Ca₁₋ₓSrₓS:Eu,I (0≦x≦1) luminescent material, the more the wavelength range is shifted to greater wavelengths.

The absorption of the Ca₁₋ₓSrₓS:Eu,I (0≦x≦1) luminescent material lies in a range from 350 nm to 500 nm, depending on the Ca content.

The method according to the invention renders it possible to manufacture, for example, SrS:Eu,I luminescent material which has the properties listed in Table I below.

TABLE I

| | |
|---|---|
| Quantum efficiency (T = 20° C., λ_{exc} = 460 nm) | >90% |
| Absorption at λ = 440-470 nm | >75% |
| Luminous efficacy | 260 Im/W |
| Color point | x = 0.626, y = 0.370 |
| 1/10 Afterglow decay time (λ_{exc} = 460 nm) | <0.7 ms |
| Thermal decay (T = 20-200° C.) | <7% |
| Average particle size | <15 μm |

The strongly luminescing, europium-doped Ca₁₋ₓSrₓS:Eu,I (0≦x≦1) materials comprising iodine anions, as manufactured by the method according to the invention, have the following advantages over europium-doped Ca₁₋ₓSrₓS (0≦x≦1) luminescent materials manufactured in accordance with the prior art:
1. the use of an iodine-sintered flowing agent for manufacturing luminescent europium-doped Ca₁₋ₓSrₓS material comprising iodine ions yields optimized particles with a high degree of absorption in the blue spectral range and a high conversion efficiency. The material manufactured in accordance with the invention is accordingly particularly suitable for color conversions in blue LEDs.
2. Compared with prior-art europium-doped strontium sulfide materials calcinated with bromine or chlorine compounds, leading to luminescent materials with long decay periods, the material according to the invention can be subsequently processed in a reducing atmosphere, preferably in a nitrogen atmosphere containing sulfur, without further measures, whereby a material of high efficiency, a short decay time, and a high thermal extinction temperature can be obtained. The latter is a result of the short decay time of the luminescence, which is an important characteristic for a suitable color converter for a lighting means, such as LEDs or laser LEDs coated with the luminescent material according to the invention, because the operating temperatures of an LED chip will exceed 200° C. in the near future.
3. The decay time of the materials according to the invention is even shorter than the time reported for SrS:Eu materials known from the prior art, which are calcinated in the presence of a strontium metal vapor.

It should be noted, furthermore, that the heating of Ca₁₋ₓSrₓS:Eu,I (0≦x≦1) according to the invention in a reducing atmosphere, in particular a nitrogen atmosphere containing sulfur, is a method that can be readily implemented on a large scale, whereas this is not possible for a method in which the luminescent material is exposed to a strontium metal vapor, because this method requires specially developed, expensive reaction chambers made from non-reactive materials.

The luminescent material according to the invention has a high thermal extinction temperature. In particular, at T=20° C. to 200° C., said high thermal extinction temperature amounts to ≦20%, preferably ≦15%, more preferably ≦10%, highly preferably ≦7%, and most preferably ≦5%.

The luminescent material according to the invention may thus be advantageously used as a luminescent means, preferably as a coating of luminescent material on lighting means.

Lighting means in the sense of the present invention comprise in particular also light-emitting components, liquid crystal picture screens, electroluminescent picture screens, fluorescent lamps, light-emitting diodes, and laser diodes coated with the luminescent material according to the invention.

The subject of the present invention will be explained in more detail by means of the manufacturing examples 1 and 2 given below, without being limited thereto.

General notes on the experimental arrangement for the manufacture of SrS:Eu,I according to the invention:

To manufacture SrS:Eu, a tubular firing chamber comprising a corundum tube was used, through which nitrogen with 1% of hydrogen by volume added thereto was made to flow. The europium-doped strontium sulfide mixed with ammonium iodide and sulfur was introduced into two aluminum oxide boats. Each boat was placed in an argon-filled corundum tube and moved to the hottest spot during calcination.

### EXAMPLE 1

Manufacture of SrS:Eu,I

Solution A

230.84 g Sr(NO₃)₂ (99.99% purity) was added to a mixture of 750 ml twice distilled H₂O and 1 ml of a concentrated aqueous solution of (NH₄)₂S. The solution was filtered through a 0.45 μm filter after 24 hours (solution A).

Solution B

157.89 g (NH₄)₂SO₄ (99,99% purity) was added to a mixture of 750 ml twice distilled H₂O and 1 ml of a concentrated aqueous solution of NH₃. The solution was filtered through a 0.45 μm filter after 24 hours (solution B).

Solution A+Solution B

The two solutions A and B were slowly joined together under stirring in 0.5 1 water-free alcohol. The SrSO₄ precipitate formed thereby was washed with twice distilled H₂O and then dried. Subsequently, 0.486 g Eu(NO₃)₃.6H₂O was dissolved in little water and stirred together with SrSO₄ into a paste. After drying, the europium-coated SrSO₄ was crushed into a powder and heated in air for one hour at 500° C. Then the sulfate was converted into sulfide by heating in a reducing gas atmosphere of 5% H₂ by volume and 95% N₂ by volume during 12 hours at 1000° C. and a subsequent heating during 4 hours in the reducing gas atmosphere under addition of dry H₂S. The SrS:Eu thus formed was milled into a powder in a ball mill after the addition of cyclohexane, and subsequently the dry powder was mixed with 3.0 g NH₄I (99.99% purity) and 10 g sulfur (99.99% purity). The mixture was put in an aluminum oxide boat and then introduced into a loosely closable, argon-filled corundum tube and heated for one hour at 1100° C. in a flow of nitrogen. Any inert gas may be used instead of argon. The luminescent material SrS:Eu,I was then washed with water-free methanol, dried, and milled for 30 minutes in a ball mill in cyclohexane. The resulting SrS:Eu,I powder was once more calcinated in a nitrogen flow containing sulfur for 1.5 hours in a loosely covered aluminum oxide boat in a corundum tube at 1000° C. The resulting SrS:Eu,I luminescent material was subjected to an ultrasonic treatment in water-free ethanol for 15 minutes, dried, and sieved (mesh size 45 μm).

### EXAMPLE 2

Manufacture of Ca₁₋ₓSrₓS:Eu,I (0≦x≦1)

Various Ca₁₋ₓSrₓS:Eu,I luminescent materials (0≦x≦1) were prepared by the method described in example 1, with the proviso that Ca_{0.25}Sr_{0.75}S, Ca_{0.5}Sr_{0.5}S, and Ca_{0.75}Sr_{0.25}S were used instead of SrS.

1. A method of manufacturing europium-doped (Ca₁₋ₓSrₓ)S (0≦x≦1) luminescent material with a short decay time and a high thermal extinction temperature, characterized in that europium-doped (Ca₁₋ₓSrₓ)S (0≦x≦1) is exposed to at least a first calcination step at high temperatures in the presence of at least one iodine compound.

2. A method of manufacturing a luminescent material as claimed in claim 1, characterized in that the europium-doped (Ca₁₋ₓSrₓ)S (0≦x≦1) luminescent material comprising iodine ions is subjected at least to a second calcination step at high temperatures.

3. A method of manufacturing a luminescent material as claimed in claim 1, characterized in that the temperatures of the calcination step are ≧900° C., preferably in a range from 950° C. to 1500° C., more preferably 1050° C. to 1200° C.

4. A method of manufacturing a luminescent material as claimed in claim 1, characterized in that the luminescent material is subjected to at least one calcination step in a reducing atmosphere, preferably an inert atmosphere containing sulfur, particularly preferably an inert atmosphere containing 2 to 4% by weight of sulfur.

5. A method of manufacturing a luminescent material as claimed in claim 1, characterized in that the iodine anion content of the luminescent material is between ≦0 and ≦5000 ppm, preferably ≦1000 ppm, more preferably ≦500 ppm, even more preferably ≦300 ppm, highly preferably ≦200 ppm, and most preferably ≦100 ppm.

6. A luminescent material having the composition (Ca₁₋ₓSrₓ)S:Eu,I (0≦x≦1).

7. A luminescent material as claimed in any claim 1, characterized in that the luminescent material has a short decay time, preferably with a 1/10 afterglow decay time for λ_{exc}=460 nm being <0.7 ms.

8. A luminescent material as claimed in claim 1, characterized in that the luminescent material has a high thermal extinction temperature, in particular said high thermal extinction temperature at T=20° C. to 200° C. amounting to ≦20%, preferably ≦15%, more preferably ≦10%, highly preferably ≦7%, and most preferably ≦5%.

9. A lighting means, characterized in that said lighting means comprises a luminescent material as claimed in claim 1, preferably a coating of luminescent material.

10. A lighting means as claimed in any one of claim 1, characterized in that the lighting means is a light-emitting component, a liquid crystal picture screen, an electroluminescent picture screen, a fluorescent lamp, and/or a light-emitting diode.
